(19) United States
(12) Patent Application Publication
(10) Pub. No.: US 2011/0139097 A1
(43) Pub. Date: Jun. 16, 2011

(54) GAS GENERATION AND MANAGEMENT SYSTEM

(76) Inventor: Anthony Scott Brown, Jacksonville, FL (US)

(21) Appl. No.: 12/635,986

(22) Filed: Dec. 11, 2009

(51) Int. Cl. F02B 43/08; F16K 15/00; F17D 1/00

(52) U.S. Cl. 123/3; 137/455; 137/10

(57) ABSTRACT

A system for generating gas includes a gas source which includes a gas generator and a gas compressor. The system also includes a gas management apparatus in a flow path between the gas source and gas sink. The gas management apparatus includes a primary pressure vessel that stores gas when a gas source flow rate exceeds a gas sink flow rate, and that releases stored gas when the gas source flow rate is less than the gas sink flow rate. The gas management apparatus also includes a primary variable state material that absorbs the gas when in an absorptive state, and releases the gas in a releasing state.

### FIELD OF THE INVENTION

This invention relates to a hydrogen generation and management system. More particularly, this invention relates to hydrogen generation and management system for powering a vehicle.

### BACKGROUND OF THE INVENTION

Hydrogen as a source of fuel for combustion, particularly for powering vehicles, has a great deal of generated interest, particularly in light of the concerns over fossil fuel supplies. Prior systems for generating hydrogen for use as a fuel supply for a vehicle have struggled to overcome several obstacles. For example, those systems that simply store hydrogen in hydrogen storage vessels must store the hydrogen at very high pressures, up to 10,000 psi, in order to sustain operation for any length of time. Such highly pressurized vessels may be under tremendous physical stress, which may lead to leakage of the hydrogen gas. In as much as hydrogen is a very flammable liquid, such leakage presents an unacceptable explosion hazard. Further, to fully charge a large vessel to 10,000 psi would require expensive, professional equipment. Such equipment is not readily available commercially, and is unlikely to be made available to the average consumer. This greatly limits vessel refilling options, which, in turn, greatly limits a consumer's ability to utilize such a system. Other systems have endeavored to create hydrogen on-board. For example, fuel cell technology has been used. However, fuel cells are limiting because they are heavy, require additional complicated equipment, and are not yet economical. Consequently, there exists a need for a hydrogen generation system that is safe, economical, and independent from commercial hydrogen filling stations.

### BRIEF DESCRIPTION OF THE INVENTION

The present invention provides an innovative gas generation and management system that can generate gas and supply generated gas at a variety of gas demand rates while maintaining relatively low gas pressures within the system. Further, upon a system shut-down, the gas management system will remove the substantial majority of the gas in the system, rendering the system safe. The gas generation and management system may be connected to any device or system that requires gas, including, but not limited to a vehicle engine. The gas generation and management system includes a gas generator, and a unique capacitance system that accumulates and dissipates the gas as required. Consequently, the gas generation and management system can accommodate systems that demand steady flows of hydrogen, and advantageously, the gas generation and management system can supply gas to systems that demand gas at unsteady flow rates. Particularly advantageously, it can supply gas for systems where the maximum gas demanded temporarily exceeds the gas generation system's maximum gas generation rate, due to the gas management system's gas capacitance. For example, the system can be integrated into a vehicle, such that the gas generation and management system can supply all the gas demanded, and can supply the gas at the rates demanded by the system, regardless of how that demand rate may change. Furthermore, the system may alternatively be used to supplement another system present in a vehicle, such that the inventive system increases fuel mileage of the vehicle even though it is not the sole source of fuel for the vehicle. The embodiment described below is directed toward a hydrogen gas generation and management system. While the hydrogen generating portion of this system is limited to generating hydrogen, as opposed to other gasses, it will become clear that any type of gas can be managed by the gas management portion of the system, and thus the gas management portion of this system could be incorporated into systems that require management of gasses other than hydrogen. All such embodiments are intended to be with the scope of this invention.

Accordingly, disclosed is a system for generating gas for a gas sink, wherein the gas sink consumes gas over a range of gas sink flow rates. The system contains a gas source with a gas generator and a gas compressor. The gas source generates the gas at a gas source flow rate that varies from zero to a maximum gas source flow rate, and the maximum gas sink flow rate is greater than a maximum gas source flow rate. The system further contains a gas management apparatus in a flow path between the gas source and gas sink. The gas management apparatus includes a primary pressure vessel. The primary pressure vessel stores gas when the gas source flow rate exceeds the gas sink flow rate, and the primary pressure vessel releases stored gas when the gas source flow rate is less than the gas sink flow rate. The primary pressure vessel mitigates pressure pulsations originating in the gas source flow. The gas management apparatus also includes a primary variable state material. The primary variable state material absorbs the gas when in an absorptive state, releases the gas in a releasing state, and the primary variable state material is characterized by a primary state transition condition, such that the primary variable state material is in a releasing state above the primary state transition condition, and an absorbing state below the primary state transition condition.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 shows a schematic representation of the gas generation and management system of the present invention, coupled with a gas consuming system.

FIG. 2 shows a side cross-section of an embodiment of a hydrogen generating PEM electrolyzer of the gas generation system of FIG. 1.

FIG. 3 shows a cross-section along A-A of an embodiment of the capacitance apparatus of the gas management system of FIG. 1.

### DETAILED DESCRIPTION OF THE INVENTION

Reference will now be made in detail to the embodiments consistent with the invention, examples of which are illustrated in the accompanying drawings. Wherever possible, the same reference numerals are used throughout the drawings and refer to the same or like parts.

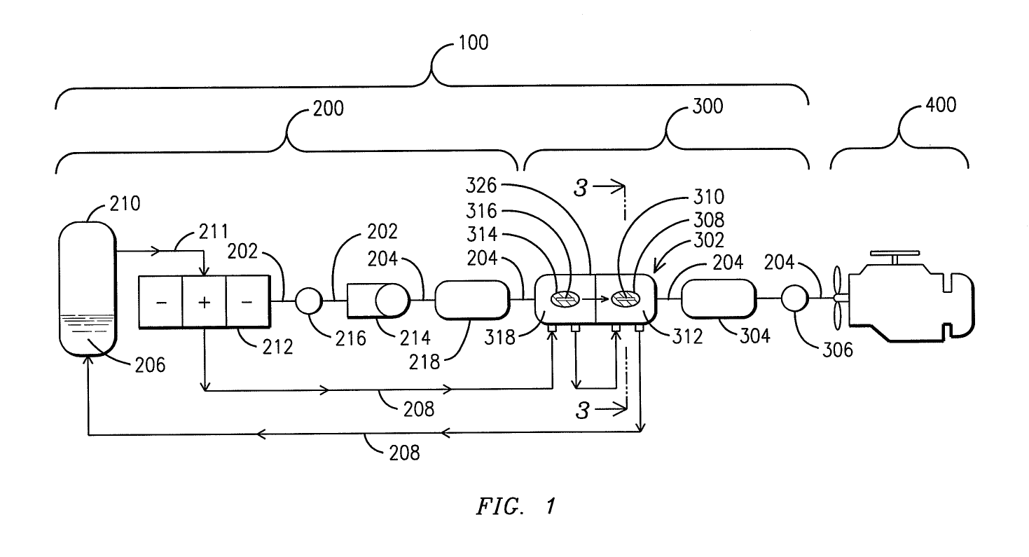

As seen in FIG. 1, the gas generation and management system 100 supplies gas to a system or device, i.e., a gas sink 400 that demands gas for operation. In an embodiment, the gas sink 400 is a combustion engine, and in particular, a combustion engine that powers a vehicle. The gas generation and management system 100 is made of two main subsystems, namely the gas generation system 200, and the gas management system 300. The gas generation system 200 generates gas 202, compresses it into compressed gas 204, and supplies the compressed gas 204 to the gas management system 300. The gas management system 300 in turn supplies the compressed gas 204 to the gas sink 400. Electrolyte solution 206 is circulated between the gas generation system 200 and the gas management system 300, via an electrolyte solution loop 208 to maintain proper temperatures within the system, as will be discussed further.

From this point forward the gas generator 212 of the gas generating and management system 100 may be referred to as a hydrogen generator 212 at times. This is not intended to limit the other components of the gas generation system 200 to only those related to hydrogen. Further, this is not intended to limit the gas management system 300 embodiments discussed to only hydrogen gas; the remainder of the gas generation system components and the gas management system 300 are intended to encompass any gas. That it is discussed as a hydrogen generator is only for purposes of describing an embodiment.

The gas generation system 200 comprises an electrolyte solution reservoir 210, a hydrogen generator 212, and a gas compressor 214. It may further comprise a vacuum regulator 216 to regulate the vacuum generated by the gas compressor, and a dryer 218, to dry the gas once compressed. The gas management system 300 comprises a capacitance apparatus 302, a dryer 304, and a pressure regulator 306. The gas generation system 200 further comprises an electrolyte solution 206, which travels in a controlled loop from the hydrogen generator 212 to the capacitance apparatus 302, to the electrolyte solution reservoir 210, and back to the hydrogen generator 212. Connectors in the components, piping between the components and other pumps are known to those of ordinary skill in the art and therefore will not be discussed further here.

The electrolyte solution 206, which comprises water and an electrolyte such as potassium hydroxide, is fed into the hydrogen generator 212 via electrolyte supply line 211. Hydrogen gas 202 is generated in the hydrogen generator 212 in a manner that will be discussed below. The hydrogen gas is compressed by gas compressor 214. Gas compressor 214 may draw a strong vacuum on the hydrogen generator 212, and thus a vacuum regulator 216 may be installed between the hydrogen generator 212 and the gas compressor 214. Gas compressor 214 may take the form of any available compressor. Commercially available units heretofore have been limited to reciprocating, piston type compressors. As a consequence, pressure pulsations are created during the compression of the gas, and those pulsations perpetuate downstream throughout the compressed gas 204. Mitigating these pressure pulsations is a function served by the gas management system 300, and is discussed in further detail below. Once compressed, the compressed gas 204 may be dried by a dryer 218. Though not necessary, this step enhances the quality of the compressed gas 204 delivered to the gas management system 300, and ultimately the gas sink 400.

In an embodiment, the gas sink 400 may be a 318 cubic inch, 8 cylinder engine internal combustion engine modified to burn hydrogen gas instead of gasoline. An embodiment of the gas generation and management system 200 described below generates enough hydrogen to sufficiently power the gas sink 400 when the gas sink is the 318 cubic inch 8 cylinder engine internal combustion engine modified to burn hydrogen gas instead of gasoline. However, the invention can be used with smaller engines, scaled up to supply enough gas for larger engines, scaled down to supply enough gas for smaller engines, and embodied to supply different gas to an internal combustion engine that uses a different gas, or a different kind of engine than an internal combustion engine.

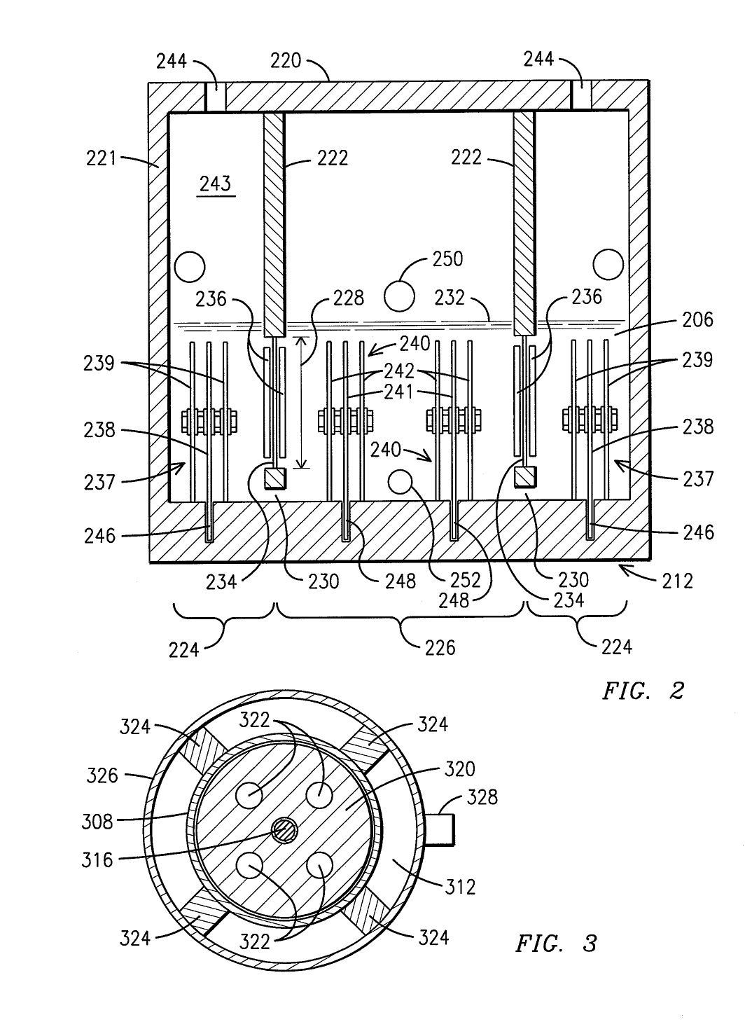

The hydrogen generator 212 can be seen in FIG. 2. It includes a vessel 220 comprising a plurality of connected sidewalls 221, a top, a bottom, and two interior gas impermeable walls 222 that divide the vessel 220 into two hydrogen generating chambers 224 that surround an oxygen generating chamber 226. Each hydrogen generating chamber 224 includes an anode 237 and a portal 244 though which hydrogen gas exits to the gas compressor 214. Each oxygen generating chamber 226 includes as many cathodes 240 as there are anodes 237, and portals for electrolyte fluid entry and exit, and electrolyte solution 206, may be comprised of water and potassium hydroxide, which is supplied from the electrolyte solution reservoir 210 via an electrolyte solution supply port 250, and completes the electric circuit. Each interior wall includes a first opening into which a proton exchange membrane is positioned, and a second opening, which permits fluid and electrons to travel from one chamber to an adjacent chamber.

The vessel 220 and interior gas impermeable walls 222 are made of Tivar H.O.T., manufactured by Quadrant EPP USA, Inc., of Reading, Pa. Both openings 228, 230 in the interior gas impermeable walls 222 are disposed below an electrolyte solution operating level 232. The proton exchange membrane 234 may be made from material such as Nafion, manufactured by E.I. du Pont de Nemours and Company of Wilmington, Del. Any fluid that traverses the first opening 228 must also traverse the proton exchange membrane 234. The proton exchange membrane 234 may be held in place by support plates 236.

Anode 237 is disposed below the operating level of the electrolyte solution 206, and proximate the proton exchange membrane 234. Anode 237 comprises a primary anode plate 238 connected to an electric source (not shown) via anode tabs 246, and secondary anode plates 239 connected to the primary anode plate 238, such that the primary anode plate 238 is the most centrally disposed plate for even power distribution throughout the anode 237 or collection of anodes 237. A nickel alloy material that serves as a variable state material is also disposed in the hydrogen generating chamber. The hydrogen generating chamber 224 also includes a hydrogen gas collection area 243 within the hydrogen generating chamber 224. Within the hydrogen gas collection area 243 is a hydrogen port 244 through which hydrogen can be delivered to the exterior of the vessel. The oxygen generating chamber 226 includes two cathodes 240, disposed below the operating level of the electrolyte solution 206, and proximate the proton exchange membrane 234. Cathodes 240 comprise primary cathode plates 241 connected to an electric source via cathode tabs 248, and secondary cathode plates 242 connected to the primary cathode plates 241, such that the primary cathode plate 241 of each cathode 240 is the most centrally disposed plate for even power distribution. Electrolyte solution 206 may be supplied to the primary and/or secondary fluid jackets 312, 318, via fluid jacket supply port 252, and may return via the portal 250.

In an embodiment, the anode 237 itself may be partially or completely made of the variable state material. In another embodiment, there may be only a single hydrogen generating chamber 224. The inventors acknowledge a variety of configurations and number of chambers may be employed, but the underlying inventive concepts remain. As such, those variations are intended to be within the scope of this invention.

In an embodiment the hydrogen generator 212 may be approximately 14″ wide, 17″ deep, and 12″ tall, with 0.75″ think gas impermeable walls 222, and may hold approximately 0.5 gallons of electrolyte solution 206. The electrolyte solution 206 may contain approximately 3.5% by volume of electrolyte, and may be maintained at a level of approximately 6″ in the hydrogen generator 212. The anode plates 238,239, and cathode plates 241, 242 may be approximately 4″×12″. The cathode plates may be comprised of 316-L stainless steel. The hydrogen generator 212 may be maintained during operation at approximately 140° F.

The gas compressor 214 may be capable of delivering a maximum flow rate of, for example, 150 liters per minute of compressed gas 204. However, the hydrogen generator 212 may produce hydrogen gas at varying rates due to various factors. For example, during operation the temperature within the hydrogen generator 212 may fluctuate, the level and chemical composition of the electrolyte solution 206 may also fluctuate, or the voltage and current delivered through the electrolyte solution 206 may vary. As a result, the amount of hydrogen gas 202 available to the gas compressor 214 may not match the capacity of the gas compressor 214. The inventor has found that, on average, the hydrogen generator 212 with the dimensions given above may generate enough hydrogen gas 202 to enable the gas compressor 214 to deliver an average of approximately 125 liters per minute of compressed gas 204. These figures are not meant to be limiting. These figures simply represent an embodiment. The inventor recognizes that as pump technology improves, and hydrogen gas generation technology evolves, that the numbers may differ from those presented. However, the inventive principles at work do not change, and different flow rates are intended to be within the scope of this invention.

In operation, the electrolyte solution operating level 232 is maintained such that the anode 237 and cathode 240 remain submerged in the electrolyte solution 206. It is known in the art that when a current is run through a circuit of this type, hydrogen gas is generated proximate the anode 237, and oxygen gas is generated proximate the cathode 240. The hydrogen gas generated by the anode 237 disperses into the hydrogen gas collection area 243. From here, the hydrogen gas 202 is pulled through hydrogen port 244 via a vacuum generated by gas compressor 214. Particularly advantageous here is that the hydrogen gas generated is kept separate from the oxygen gas, thus preventing loss of hydrogen gas that occurs if the two are not separated, and portions of the hydrogen gas and oxygen gas recombine subsequently.

Proton exchange membranes and their characteristics are known to those in skilled in the pertinent art. A characteristic of a proton exchange membrane 234 utilized in the present invention is that such a membrane conducts cations (protons), such as hydrogen protons, but not anions (electrons). It is known that the proton exchange membrane 234 used in an embodiment must be maintained at an operating temperature of over approximately 100° F., and submerged in the electrolyte solution 206 in order to function properly. The inventor acknowledges that variations exist that might require different operating temperatures, but the inventive concepts remain, and the variations are intended to be within the scope of this invention. Thus, in this configuration, where anode 237 is positioned proximate the proton exchange membrane 234, hydrogen protons are able to traverse the proton exchange membrane 234 into the oxygen generating chamber 226, but oxygen anions are not able to traverse the proton exchange membrane 234 to enter the hydrogen generating chamber 224. An advantage of this configuration is that any hydrogen cations that travel into the oxygen generating chamber 226 may combine with oxygen anions to form water, thus reducing the oxygen anions, but no oxygen anions can travel through the proton exchange membrane 234 into the hydrogen generating chamber 224. This ensures the purity of the hydrogen that is drawn from the hydrogen generating chamber 224.

As discussed in more detail below, the temperature of the hydrogen generator 212 may be regulated by removing electrolyte solution 206 heated by the hydrogen generation process, and/or adding more electrolyte solution 206 from the electrolyte solution reservoir 210, which is cooler. The excess heat may be used for thermal regulation of other components within the gas generation and management system 100 as necessary. The sensors, pumps, valves, and piping etc use to accomplish this thermal regulation are known to those in the art and thus will not be discussed in any more detail.

The gas management system 300 comprises a capacitance apparatus 302. The gas management system 300 may also comprise a dryer 304, depicted in FIG. 2, downstream of the capacitance apparatus 302, and a pressure regulator 306 between the capacitance apparatus 302 and the gas sink 400. The capacitance apparatus 302 comprises at least a primary pressure vessel 308, a primary variable state material 310, and a means for thermally regulating the primary variable state material 310, which, in an embodiment, is a primary fluid jacket 312 through which a fluid, such as electrolyte solution 206 from the hydrogen generator 212, may be circulated. The primary variable state material 310 may be disposed within the primary pressure vessel 308, it may be in a separate location, for example in its own vessel, or it may form part of the primary pressure vessel structure, or piping etc, or all or any combination of all of these possibilities. The embodiment described herein includes the primary pressure vessel 308, a secondary pressure vessel 314, a secondary variable state material 316, and a means for thermally regulating the secondary variable state material 316, which, in an embodiment, is a secondary fluid jacket 318 through which a fluid, such as electrolyte solution 206 from the hydrogen generator 212, may be circulated. The secondary pressure vessel 314 may be disposed between the gas generation system 200 and the primary pressure vessel 308. The secondary variable state material 316 may be disposed within the secondary pressure vessel 314, it may be in a separate location, or it may form part of the secondary pressure vessel structure, or piping etc, or all or any combination of all of these possibilities. The secondary variable state material may be the same material as the primary variable state material, or may be another material that absorbs the gas being managed. The secondary variable state material may vary in that the equilibrium point may be higher or lower, and/or the interrelation of pressure and temperature may alter the absorption and/or release rates.

Providing a secondary pressure vessel 314 and secondary variable state material 316 adds flexibility to the gas management system 300. For example, gas storage capacity can be increased by adding a second, or more, vessels. Gas storage capacity may be split among two or more vessels, to ease design constraints. However, single vessel systems are envisioned as embodiments and are intended to be within the scope of this disclosure. Such a single vessel system would be the system as described above, without the secondary pressure vessel 314, the secondary variable state material 316, and the second the secondary fluid jacket 318.

A variable state material is defined herein to be a material that has at least three states. In one state the material absorbs a gas. i.e., an absorptive state. In another state the material releases stored gas. i.e., a releasing state. Another state is simply a neutral state of equilibrium in between the absorbing state and the releasing state. The state of the material is determined generally by an interrelation of temperature, and pressure of the variable state material and the gas, or, more particularly, the partial pressure of the gas in contact with the material. Thus, conditions can be created such that the variable state material will release gas when desired, and absorb gas when desired. The discussion below is for an embodiment where hydrogen is the gas that is absorbed and released. The fundamental concepts of this invention can be used with any gas, so long as there is a variable state material that will absorb or release the gas based on the operating conditions, and the invention is not intended to be limited to variable state materials that work only with hydrogen.

Variable state materials that absorb hydrogen do so by forming a metal hydride. Conversely, metal hydrides release hydrogen by decomposing the metal hydride. These materials are known to those in the art, and can store large amounts of hydrogen at low pressures and in relatively small volumes. These materials include, but are not limited to materials such as nickel-metal hydrides. In particular, the inventor has used a rod made of nickel 200, a commercially pure, wrought nickel. Information regarding the state of the material at various temperatures and pressures is readily available from the manufacturers. Further, the temperatures and pressures that create absorbing states and releasing states of certain variable state materials can be recreated by the components of the gas generation and management system. Thus, the gas generation and management system can control the state of the variable state material as needed. Matching the right material with the design requirements is relatively straightforward, and is known to those in the art, so it need not be discussed in great detail here. In an embodiment, the variable state material's transition condition, or equilibrium point, occurs at about 80° F. However, other temperatures could be used depending on the system requirements.

As can be seen in FIG. 3, the capacitance apparatus may include a nickel 200 rod 316 (i.e., 200 grade pure nickel) disposed in the center of each the pressure vessel 308, 314. In an embodiment, the pressure vessel itself may be comprised of a variable state material, such as a Ni alloy. The nickel 200 rod may be held in place by a spacer 320. Spacer 320 may include holes 322 through which the gas 204 may flow. The pressure vessel 308, 314 may in turn be held in place with supports 324 which secure the pressure vessel 308, 314 inside the outer casing 326. The space between the pressure vessel 308, 314 and the outer casing 326 defines the fluid jackets 312, 318. Fluid enters the primary fluid jacket 312 through a primary fluid jacket inlet (not shown) and exists through a primary fluid outlet 328. Fluid enters the secondary fluid jacket 318 through a secondary fluid jacket inlet (not shown) and exits through a secondary fluid jacket outlet (not shown).

Thermal regulation of the variable state materials can be accomplished in any number of ways, and all are intended to be within the scope of this invention. In an embodiment, such as the one described herein, thermal regulation of the primary variable state material 310 may be accomplished via a primary fluid jacket 312 in thermal communication with the primary pressure vessel 308 through which a fluid may flow, such that heat may flow from the fluid to the primary variable state material 310 inside the primary pressure vessel 308, or vice versa. In this manner the state of the primary variable state material 310 can be controlled. Thermal regulation of the secondary variable state material 316 may be accomplished via a secondary fluid jacket 318 in thermal communication with the secondary pressure vessel 314 through which a fluid may flow, such that heat may flow from the fluid to the secondary variable state material 316 inside the secondary pressure vessel 314, or vice versa. In this manner the state of the secondary variable state material 318 can be controlled. The fluid that enters the secondary fluid jacket 318 may be composed partly or entirely of electrolyte solution 206 from the gas generator 212. The fluid that enters the primary fluid jacket 312 may be composed partly or entirely of the fluid that leaves the secondary fluid jacket 318. The fluid that exits the primary fluid jacket 312 may be returned to the electrolyte solution reservoir 210. Pumps and temperature sensors known to those in the art may control the flow and composition of the fluids, and will not be discussed in detail. In the embodiment shown, electrolyte solution 206 from the gas generator 212 is the sole fluid circulated to the jacket or jackets. However, the inventor recognizes that other fluids may be mixed in with the electrolyte solution 206 in order to achieve the appropriate temperatures at the desired locations. Such fluid mixtures and fluid temperature control is intended to be within the scope of this invention.

In an embodiment, the pressure in the primary pressure vessel 308 and the secondary pressure vessel 314 may be maintained from about 75 psig to about 150 psig. The temperature of the primary variable state material 310 in the primary pressure vessel 308 may be maintained at approximately 80° F., while the temperature of the secondary variable state material 316 in the secondary pressure vessel 314 may be maintained at approximately 140° F. Each of the pressure vessels 308, 314 may be approximately 2″ in diameter by 8″ long, (i.e., approximately 20 cubic inches in volume. The variable state materials 310, 316 may be approximately 1″ in diameter×6″ long, and be able to absorb approximately 13,800 standard liters of hydrogen.

In operation, compressed gas 204 generated by the gas generation system 200 is delivered to the secondary pressure vessel 314 of the capacitance apparatus 302, then to the primary pressure vessel 308 of the capacitance apparatus 302. The secondary pressure vessel 314 and the primary pressure vessel 308 are directly connected, and other than any flow losses between them, they maintain essentially the same pressure as each other. What happens regarding the gas 204 in the pressure vessels 308, 314 depends on the compressed gas flow rate into the secondary pressure vessel 314 and the compressed gas flow rate out of the primary pressure vessel 308. The compressed gas flow rate out of the primary pressure vessel 308 is determined by the gas sink 400 demand for compressed gas 204. For example, but not limiting, when the gas sink 400 is a vehicle engine, during high demand periods such as during acceleration, the demanded compressed gas flow rate will be greater than when cruising at steady speeds. Thus the gas sink 400 demand for compressed gas 204 may vary greatly during operation. When the compressed gas flow rate into the secondary pressure vessel 314 is greater than the compressed gas flow rate out of the primary pressure vessel 308, (i.e., the gas sink 400 demand for compressed gas), then compressed gas 204 will accumulate within the primary pressure vessel 308 and pressure in the primary pressure vessel 308 will increase. Simply put, in that circumstance more compressed gas 204 will be flowing into the pressure vessels 308, 314 than will be flowing out, and consequently compressed gas 204 will accumulate in the pressure vessels 308, 314. Conversely, when the compressed gas flow rate into the secondary pressure vessel 314 is less than the compressed gas flow rate out of the primary pressure vessel 308, the compressed gas 204 that has accumulated in the pressure vessels 308, 314 will begin to dissipate, i.e., accumulated compressed gas will dissipate from the pressure vessels 308, 314 to be delivered to the gas sink 400.

If the gas generation system 200 were capable of delivering compressed gas 204 such that it could always meet the gas sink demand, then the gas generation system 200 could deliver compressed gas 204 directly to the gas sink 400, without an intervening gas management system 300. However, the inventor recognized that in the case where the gas generation system 200 were capable of delivering compressed gas 204 such that it could always meet the gas sink demand, introducing a gas management system 300 may lengthen the life of a gas compressor 214, because the gas compressor 214 may not need to operate as often, and/or it may permit the use of a less expensive gas compressor 214. Gas compressors 214 in the current technology are very expensive, and thus this becomes an important factor.

However, as is the case in the embodiment discussed, where the gas generation system 200 can deliver compressed gas 204 such that it meets most, but not all of the gas sink 400 demand rates, the gas management system 300 enables the gas generation system 200 to serve as the sole source of hydrogen gas over the entire range of gas sink operation, despite the fact that at times the gas generation system itself might not be able to keep up with gas sink demands. In essence, stored gas in the pressure vessels 308, 314 acts as a second source of compressed gas 204 for those times when the gas sink 400 demand rate exceeds the output capacity of the gas generation system 200.

In an example embodiment, the gas generation system 200 may deliver compressed gas 204 such that it meets most, but not all of the gas sink 400 demand rates, the gas generation system 200 may deliver an average of 125 liters per minute of compressed gas 204, and the gas sink 400 may demand anywhere from 80 liters per minute to 150 liters per minute of compressed gas 204. It can be seen that so long as the average gas generation system 200 delivery rate of 125 liters per minute exceeds the average gas sink demand rate, then over time the gas generation system 200, when coupled with the gas management system 300, should sufficiently supply the gas sink 400. In the inventor's experience, the pressure in the primary pressure vessel 308, and any additional pressure vessels, may often be in the 150 psi range during operation. There may be times when transient gas sink demands could deplete the supply of gas in the capacitance apparatus 302, (i.e., the stored gas accumulated in the pressure vessels 308, 314), at which point the gas generation system 200 would deliver only as much compressed gas as the gas compressor 214 may deliver. However, the inventor recognizes that despite the fact that engineering trade-offs are inevitable in such a system, properly sizing the components and matching the gas generation and management system 100 to the application will greatly minimize such instances.

The capacitance apparatus 302 serves another function. It mitigates pressure pulsations emanating from the gas compressor 214. As noted earlier, gas compressors of the current technology include reciprocating, piston pumps. These pumps compress and deliver compressed gas sporadically, which results in pressure spikes (i.e., pulsations) being introduced into the compressed gas flow. Were these pressure pulsations not mitigated, the pressure of the compressed gas delivered to the gas sink 400 would not be steady, but would vary. Consequently, the gas sink 400 would not receive a steady flow of compressed gas 204. The volume of the primary pressure vessel 308, together with the internal baffling effect, serves to mitigate these pressure pulsations, which improves the quality of the delivered compressed gas 204.

When the gas sink 400 is powered-down, i.e., shut-down, gas generation and management system 100 is also shut-down. The compressed hydrogen in conventional hydrogen powered systems simply sits idle in the gas flow path between a hydrogen generator and a gas sink, under varying, and sometimes extreme pressures. The gas flow path is defined herein to be the entire volume where gas is present from where gas originates to where it is consumed. As a result, there exists a safety hazard not only from the mechanical pressures present on the pressure vessel, but from any flammable hydrogen that may leak out. The inventor recognizes that in industrial settings, with knowledgeable and experienced personnel, leaks may be minimized, but they still do exist. However, a consumer is unlikely to be as knowledgeable and experienced, and the operating conditions to which the gas generation and management system 100 would be subjected are likely to be less controlled, and thus minimizing this risk is of paramount importance. In response to this need, the capacitance apparatus 302 has been designed to include yet another innovative feature. The primary variable state material 310 is included, as part of the capacitance apparatus 302, either within a primary pressure vessel 308, 314 and/or outside of the pressure vessel 308, 314 but within the path of the compressed gas 204. As discussed above, a variable state material 310, 316 can absorb the compressed gas 204, it can release hydrogen into the compressed gas 204, or in a neutral state, it may do neither. In the capacitance apparatus 302, upon shut-down, the variable state material 310, 316, which is likely to be in a gas releasing state during operation, begins to cool, and eventually transition to a gas absorbing state. Once in a gas absorbing state, the variable state material 310, 316 begins to absorb the compressed gas 204 in the gas flow path. The system can be configured to permit the variable state material 310, 316 to absorb most, or all, of the compressed gas 206 in the gas flow path. The inventor acknowledges that both designs would be the result of a balancing of factors, including the operating temperatures and pressures in the gas flow path, ambient temperatures, (and thus the amount of time it takes the variable state material 310, 316 to cool), the amount of time the system is powered down, and the amount and type of variable state material 310, 316. In an embodiment it is preferred that a residual amount of the gas be left in the gas path. This residual amount would be used to supply the gas sink 400 during a subsequent start-up of the gas generation and management system 100. This would be necessary because it may take the gas generation system 200 several minutes before it is delivering hydrogen gas in quantities sufficient to meet the gas sink 400 demand. Having a residual amount of gas in the gas flow path would supply the gas sink 400 with gas until the gas generation system 200 comes online. Although having no gas in the gas flow path would be the safest, a residual amount of gas would not pose a significant hazard, but would provide a significant benefit, i.e., enabling instant system operation.

The variable state material 310, 316 presents one further benefit. When under operating conditions, the primary variable state material 310 may be releasing gas into the gas flow path, increasing the amount of compressed gas 204. This may also improve the quality of the delivered compressed gas 204.

Additionally, the state of the variable state material 310, 316 can be controlled such that its state is independent of the operating conditions in the gas path. Thus, the variable state material 310, 316 can be in a state it would not be when without the thermal regulation. For example, if without the thermal regulation the variable state material 310, 316 would be in a gas releasing state, it can be maintained in a neutral, or gas absorbing state by cooling it. Alternatively, if without the thermal regulation the variable state material 310, 316 would be in a gas absorbing state, it can be maintained in a neutral, or gas releasing state by heating it. What state the variable state material 310, 316 is maintained in is a matter of design choice, and all variations are intended to be within the scope of this disclosure.

In one embodiment, the temperature of the primary variable state material 310 is maintained such that it will enter or be in a gas absorbing state shortly after shut-down. To accomplish this the primary variable state material 310 could be maintained near a neutral state, such that upon a shut down it is closer to a gas absorbing state (i.e., it is cooler) than it would have been were it not cooled. Alternatively, since it is possible that upon shut-down, when the thermal regulation also ceases, the primary variable state material 310 may increase in temperature until it meets the temperature of the rest of the gas generation and management system 100 as the system cools down, it is contemplated maintaining the primary variable state material 310 at such a temperature that even though it does warm for a first portion of a system shut-down cooling period, it does not warm enough to transition a gas absorbing state. (i.e., it remains in a gas absorbing state throughout the entire shut down period.) This has the advantage of providing an almost immediate reduction of gas in the gas path, shortening the time it takes to remove all but the residual amount of gas in the gas path, and thus more quickly reducing the risks associated with compressed, flammable gas. The inventor acknowledges that choosing the proper material to serve as the primary variable state material is a matter of matching known characteristics of variable state materials with the system requirements. The underlying concepts remain, and variations in materials are intended to be within the scope of this invention.

In an embodiment, the secondary variable state material 316 may be kept in a gas releasing state, while the primary variable state material 310 may be kept at or near a gas absorbing state, as discussed above. In an embodiment, the equilibrium point of the secondary variable state material is the same or similar to that of the primary variable state material, but the secondary variable state material is maintained in a different state than the primary variable state material during operation, such that it is in a releasing state during operation. In this manner two purposes are simultaneously served by the variable state materials. The secondary variable state material 316 releases hydrogen gas into the compressed gas 204 flow during operation. Upon shut-down, the primary variable state material 310 more quickly enters, or remains in, the hydrogen absorption state, thereby more quickly rendering the gas generation and management system 100 less susceptible to the dangers associated with compressed, flammable gas. Subsequent to shut-down, when the secondary variable state material 316 cools sufficiently, it too will then enter a gas absorbing state, and assist in removing hydrogen from the gas path.

In an embodiment, the hydrogen generator 212 is regulated to an average temperature of approximately 140° F. Warmed electrolyte solution 206 from the hydrogen generator 212 is circulated into the secondary fluid jacket 318 where it warms the secondary variable state material 316. Sufficient heat is transferred to the secondary variable state material 316 such that when electrolyte solution 206 exits the secondary fluid jacket 318 and enters the primary fluid jacket 312, it is at a temperature that will maintain the primary variable state material in a neutral or hydrogen absorbing state, or sufficiently close to a hydrogen absorbing state that it will enter a hydrogen absorbing state upon shut-down sooner than will the secondary variable state material 316.

It can be seen that the inventor has innovatively created a gas generation and management system that provides a steady flow of compressed gas to a gas sink that may, at times, demand a greater flow rate than the individual components of the gas generation and management system could deliver. The gas generation and management system also provides compressed gas during start-up operations, yet renders the gas generation and management system much safer than conventional compressed gas systems by minimizing the amount of compressed gas present in the gas generation and management when the system is not operational. All this is done while minimizing the cost of components, in a simple, yet effective manner.

While the preferred embodiments of the present invention have been shown and described herein, it will be obvious that such embodiments are provided by way of example only and not of limitation. Numerous variations, changes and substitutions will occur to those skilled in the art without departing from the teaching of the present invention. Accordingly, it is intended that the invention be interpreted within the full spirit and scope of the appended claims.

What is claimed is:

1. An apparatus for managing gas in a system comprising a gas source being capable of generating a gas flow over a range of gas source flow rates, a gas sink that consumes gas over a range of gas sink flow rates, wherein a gas sink maximum flow rate is greater than a gas source maximum flow rate, and a gas path between the gas source and the gas sink, wherein the apparatus forms part of the gas path, the apparatus comprising:
at least one primary pressure vessel, wherein the primary pressure vessel stores gas when the gas source flow rate exceeds the gas sink flow rate, and wherein the primary pressure vessel releases stored gas when the gas source flow rate is less than the gas sink flow rate, and wherein the primary pressure vessel mitigates pressure pulsations in the gas originating from the gas source; and
at least one primary variable state material, wherein the primary variable state material absorbs the gas when in an absorptive state, releases the gas in a releasing state, and wherein the primary variable state material is characterized by a primary state transition condition, such that the primary variable state material is in a releasing state above the primary state transition condition, and an absorbing state below the primary state transition condition.

2. The apparatus of claim 1, wherein the primary variable state material is disposed within the primary pressure vessel.

3. The apparatus of claim 1, wherein the gas is hydrogen, the gas sink is an internal combustion engine, and the primary variable state material is comprised of a nickel alloy.

4. The apparatus of claim 1, further comprising:
a primary state controlling mechanism, wherein the state controlling mechanism maintains the primary variable state material at or near the primary transition condition during system operation.

5. The apparatus of claim 4, wherein the primary variable state material is disposed within the primary pressure vessel, and
wherein the state controlling mechanism comprises a primary jacket in thermal communication with the primary variable state material which a primary fluid is circulated for controlling the state of the primary variable state material.

6. The apparatus of claim 5, further comprising:
a secondary pressure vessel disposed between the primary pressure vessel and the gas source, wherein the secondary pressure vessel stores gas when the gas source flow rate exceeds the gas sink flow rate, and releases stored gas when the gas source flow rate is less than the gas sink flow rate, and wherein the secondary pressure vessel also mitigates pressure pulsations in the gas originating from the gas source;
a secondary variable state material characterized by a secondary state transition condition; and
a secondary state controlling mechanism for controlling the state of the secondary variable state material, wherein the secondary variable state material is in a gas absorbing state when below the secondary state transition condition, and wherein the secondary state transition condition is a temperature of approximately 80° F.,
wherein the secondary state controlling mechanism maintains the secondary variable state material in a releasing state during system operation.

7. The apparatus of claim 6, wherein the secondary variable state material is disposed within the secondary pressure vessel.

8. The apparatus of claim 6, wherein the primary transition condition and the secondary transition condition are the same.

9. The apparatus of claim 8, wherein the gas is hydrogen, the gas sink is an internal combustion engine, and the primary variable state material and the secondary variable state material are comprised of a nickel alloy.

10. The apparatus of claim 9, wherein the nickel alloy is characterized by a transition condition that is a temperature of approximately 80° F.

11. The apparatus of claim 6, wherein the state controlling mechanism comprises a secondary jacket in thermal communication with the secondary variable state material through which a secondary fluid is circulated for controlling the state of the secondary variable state material.

12. The apparatus of claim 11, wherein the primary fluid comprises at least a portion of the secondary fluid after the secondary fluid has exited the secondary jacket.

13. A method of managing gas in a system comprising a gas source capable of generating a gas flow over a range of gas source flow rates, a gas sink that consumes gas over a range of gas sink flow rates, wherein a gas sink maximum flow rate is greater than a gas source maximum flow rate, and a gas path between the gas source and the gas sink, the method comprising:
receiving gas generated by the gas source in a primary pressure vessel;
delivering the gas from the primary pressure vessel to the gas sink;
storing gas in the primary pressure vessel when the gas source flow rate exceeds the gas sink flow rate;
releasing stored gas when the gas source flow rate is less than the gas sink flow rate;
mitigating pressure oscillations in the gas flow originating from the gas source; and
absorbing gas from the gas path into a primary variable state material when the primary variable state material is in a gas absorbing state, wherein the primary variable state material is in a gas absorbing state when below the primary state transition condition.

14. The method of claim 13, wherein the primary state transition condition is a temperature of approximately 80° F.

15. The method of claim 13, further comprising:
locating the primary variable state material inside the primary pressure vessel.

16. The method of claim 13, wherein the gas is hydrogen, the gas sink is an internal combustion engine, and wherein the primary variable state material is comprised of a nickel based alloy.

17. The method of claim 13, further comprising:
maintaining the primary variable state material at or near the primary state transition condition while the system is operating using a primary state controlling mechanism.

18. The method of claim 13, further comprising:
maintaining the primary variable state material in a gas absorbing state while the system is operating, under such conditions that upon a system shut-down, the primary variable state material will remain in a gas absorbing state.

19. The method of claim 17, further comprising:
locating the primary variable state material inside the primary pressure vessel, and
directing a primary fluid through a primary pressure vessel jacket, wherein the primary pressure vessel jacket is in thermal communication with the primary variable state material, and the primary fluid controls the state of the primary variable state material.

20. The method of claim 13, further comprising:
receiving the gas from the gas source in a secondary pressure vessel;
delivering the gas from the secondary pressure vessel to the primary pressure vessel, wherein the secondary pressure vessel also stores gas when the gas source flow rate exceeds the gas sink flow rate, and wherein the secondary pressure vessel also releases stored gas when the gas source flow rate is less than the gas sink flow rate, and wherein the secondary pressure vessel together with the primary pressure vessel mitigate pressure pulsations in the gas source flow originating from the gas source;
maintaining a secondary variable state material in a gas releasing state while the system is operating using a secondary state controlling mechanism, wherein the secondary variable state material is in a gas absorbing state when below the secondary state transition condition, and wherein the secondary state transition condition is a temperature of approximately 80° F.;
releasing gas into the gas path from the secondary variable state material while the system is operating; and
maintaining a combined absorptive capacity in both of the variable state materials sufficient to absorb a substantial majority of the gas in the system upon a system shutdown.

21. The method of claim 20, further comprising locating the primary variable state material inside the primary pressure vessel and the secondary variable state material inside the secondary pressure vessel.

22. The method of claim 20, wherein the primary state transition condition and the secondary state transition condition are the same.

23. The method of claim 22, wherein the gas is hydrogen, the gas sink is an internal combustion engine, and the primary variable state material and the secondary variable state material are comprised of a nickel alloy.

24. The method of claim 20, further comprising:
locating the secondary variable state material inside the secondary pressure vessel; and
directing a secondary fluid through a secondary pressure vessel jacket, wherein the secondary pressure vessel jacket is in thermal communication with the secondary variable state material, and the secondary fluid controls the state of the secondary variable state material.

25. The method of claim 24, further comprising using the secondary fluid as a source for the primary fluid.

26. The method of claim 13, further comprising permitting a residual amount of the gas to remain in the gas path, after the system ceases operating, sufficient to supply the gas sink until the gas source produces enough freshly generated gas to supply the gas sink upon a subsequent system startup.

27. A system for generating gas for a gas sink, wherein the gas sink consumes gas over a range of gas sink flow rates, comprising:
a gas source comprising a gas generator and a gas compressor, wherein the gas source generates the gas at a gas source flow rate that varies from zero to a maximum gas source flow rate, wherein the maximum gas sink flow rate is greater than a maximum gas source flow rate; and
a gas management apparatus in a flow path between the gas source and gas sink, the gas management apparatus comprising:
a primary pressure vessel, wherein the primary pressure vessel stores gas when the gas source flow rate exceeds the gas sink flow rate, and wherein the primary pressure vessel releases stored gas when the gas source flow rate is less than the gas sink flow rate, and wherein the primary pressure vessel mitigates pressure pulsations originating in the gas source flow; and
a primary variable state material, wherein the primary variable state material absorbs the gas when in an absorptive state, releases the gas in a releasing state, and wherein the primary variable state material is characterized by a primary state transition condition, such that the primary variable state material is in a releasing state above the primary state transition condition, and an absorbing state below the primary state transition condition.

28. The apparatus of claim 27, wherein the primary variable state material is disposed within the primary pressure vessel.

29. The apparatus of claim 27, wherein the gas is hydrogen, the gas sink is an internal combustion engine, and the primary variable state material is comprised of a nickel alloy.

30. The apparatus of claim 27, wherein the gas management apparatus further comprises:
a primary state controlling mechanism, wherein the primary state controlling mechanism maintains the primary variable state material at or near the state transition condition during system operation.

31. The apparatus of claim 30, wherein the primary variable state material is disposed within the primary pressure vessel, and
wherein the primary state controlling mechanism comprises a primary jacket in thermal communication with the primary variable state material through which a primary fluid is circulated for controlling the state of the primary variable state material.

32. The system of claim 31, wherein the state controlling fluid absorbs heat released by the gas generator and transfers the heat to both of the variable state materials.

33. The apparatus of claim 31, wherein the gas management apparatus further comprises:
a secondary pressure vessel disposed between the primary pressure vessel and the gas source, wherein the secondary pressure vessel stores gas when the gas source flow rate exceeds the gas sink flow rate, and wherein the secondary pressure vessel releases stored gas when the gas source flow rate is less than the gas sink flow rate, and wherein the secondary pressure vessel mitigates pressure pulsations in the gas originating from the gas source;
a secondary variable state material characterized by a secondary state transition condition, wherein the secondary variable state material is in a gas absorbing state when below the secondary state transition condition, and wherein the secondary state transition condition is a temperature of approximately 80° F.; and
a secondary state controlling mechanism for controlling the state of the secondary variable state material,
wherein the secondary state controlling mechanism maintains the secondary variable state material in a releasing state during system operation.

34. The apparatus of claim 33, wherein the secondary variable state material is disposed within the secondary pressure vessel.

35. The apparatus of claim 33, wherein the primary variable state material transition condition and the secondary variable state material transition condition are the same.

36. The apparatus of claim 35, wherein the gas is hydrogen, the gas sink is an internal combustion engine, and the primary variable state material and the secondary variable state material are comprised of a nickel alloy.

37. The apparatus of claim 36, wherein the nickel alloy is characterized by a transition condition that is a temperature of approximately 80° F.

38. The apparatus of claim 33, wherein the secondary state controlling mechanism comprises a secondary jacket in thermal communication with the secondary variable state material through which a secondary fluid is circulated for controlling the state of the secondary variable state material.

39. The apparatus of claim 38, wherein the primary fluid is comprises the secondary fluid after the secondary fluid has exited the secondary jacket.

40. The system of claim 39, wherein the state controlling fluid absorbs heat released by the gas generator and transfers the heat to both of the variable state materials.

41. The system of claim 27, wherein:
the gas is hydrogen, and wherein the gas source is a PEM electrolyzer comprising:
a fluid reservoir;
a vessel holding an electrolyte solution;
a gas impermeable wall dividing the vessel into a hydrogen generating chamber and an oxygen generating chamber, the gas impermeable wall comprising a first opening and a second opening both disposed below an operating level of the electrolyte solution, wherein the second opening permits the electrolyte solution to traverse the gas impermeable wall;
a PEM installed in the first opening such that any fluid communication through the first opening must pass through the PEM;
an anode in the hydrogen generating chamber, disposed below the operating level of the electrolyte solution and proximate the PEM;
a nickel alloy material disposed in the hydrogen generating chamber, wherein the nickel alloy material absorbs hydrogen when below approximately 80° F., and releases hydrogen when above approximately 80° F.;
a cathode in the oxygen generating chamber, disposed below the operating level of the electrolyte solution; and
a hydrogen gas collection area within the hydrogen generating chambers comprising a port through which hydrogen can be delivered to the exterior of the vessel; wherein the anodes and cathodes are connected to an external electric source.

42. The system of claim 41, wherein the anode is comprised of the nickel alloy material.

43. The system of claim 41, wherein:
a second gas impermeable wall comprising a second PEM disposed in the second gas impermeable wall, such that the first and second gas impermeable walls create three chambers, wherein the third chamber is an additional hydrogen generating chamber comprising an anode and a nickel alloy material, and wherein the oxygen generating chamber is disposed between the hydrogen generating chambers.

44. The system of claim 43, wherein the anodes are comprised of the nickel alloy material.

45. The system of claim 41, further comprising:
a primary state controlling mechanism comprising a primary jacket in thermal communication with the primary variable state material through which a primary fluid is circulated for controlling the state of the primary variable state material;
a secondary state controlling mechanism comprises a secondary jacket in thermal communication with the secondary variable state material through which a secondary fluid is circulated for controlling the state of the secondary variable state material; and
a pump for circulating electrolyte solution from the PEM electrolyzer through the second and primary jackets, and back to the PEM electrolyzer.

46. A vehicle with an internal combustion engine as the gas sink comprising the system of claim 27.

47. A method for powering a gas sink, comprising:
generating gas using a gas generator;
compressing the gas into compressed gas using a gas compressor;
delivering compressed gas at a compressed gas source flow rate from the gas compressor to a gas management apparatus comprising:
a first pressure vessel; and
a primary variable state material,
delivering the compressed gas from the gas management apparatus to a compressed gas sink at a compressed gas sink flow rate that varies from zero to a maximum compressed gas sink flow rate;
storing compressed gas in the primary pressure vessel when the compressed gas source flow rate is greater than the compressed gas sink flow rate;
releasing compressed gas from the primary pressure vessel when the compressed gas source flow rate is less than the compressed gas sink flow rate;
mitigating pressure pulsations in the compressed gas flow originating from the gas source; and
absorbing gas from the gas path into a primary variable state material when the primary variable state material is in a gas absorbing state, wherein the primary variable state material is in a gas absorbing state when below the primary state transition condition, and wherein the primary state transition condition is a temperature of approximately 80° F.

48. The method for powering a gas sink of claim 47, wherein the gas generator comprises a vessel comprising at least one oxygen generating chamber comprising a cathode, and at least one hydrogen generating chamber comprising an anode, wherein the chambers are separated by a gas impermeable wall comprising a first opening and a second opening, wherein electrolyte solution is free to pass through the second opening, and wherein any fluid communication through the first opening must pass through a PEM, the method comprising:
maintaining a temperature within the vessel of over 85° F. during operation;
absorbing hydrogen present in the hydrogen generating chamber when the temperature within the vessel falls below approximately 85° F. using a variable state material placed in the hydrogen chamber, wherein the variable state material absorbs hydrogen when the variable state material temperature falls below approximately 80° F.;
supplying electrolyte solution from a reservoir to the vessel;
maintaining the electrolyte solution level such that the anode, cathode, and PEM remain submerged during operation, and the PEM remains submerged even when the system is not operating;
supplying electricity from an external source such that the electrolyte solution forms part of the electric path in the vessel;
delivering any hydrogen that is generated in the hydrogen generating chamber; and
permitting any hydrogen that passes through the PEM into the oxygen generating chamber to combine with any oxygen present in the oxygen chamber.

49. The method for powering a gas sink of claim 48, wherein the anode is comprised of the variable state material.

50. The method for powering a gas sink of claim 48, wherein the vessel comprises two gas impermeable walls each comprising a first opening and a second opening, wherein the walls form two hydrogen generating chambers each comprising an anode surrounding a single oxygen generating chamber comprising a cathode.

51. The method for powering a gas sink of claim 50, wherein the anodes are comprised of the variable state material.

52. The method of claim 47, further comprising:
locating the primary variable state material inside the primary pressure vessel.

53. The method of claim 47, wherein the gas is hydrogen, the gas sink is an internal combustion engine, and wherein the primary variable state material is comprised of a nickel based alloy.

54. The method of claim 47, further comprising:
maintaining the primary variable state material at or near the primary state transition condition while the system is operating using a primary state controlling mechanism.

55. The method of claim 47, further comprising:
maintaining the primary variable state material in a gas absorbing state while the system is operating, under such conditions that upon a system shut-down, the primary variable state material will remain in a gas absorbing state.

56. The method of claim 54, further comprising:
locating the primary variable state material inside the primary pressure vessel; and
directing a primary fluid through a primary pressure vessel jacket, wherein the primary pressure vessel jacket is in thermal communication with the primary variable state material, and the primary fluid controls the state of the primary variable state material.

57. The method of claim 47, further comprising:
receiving the gas from the gas source in a secondary pressure vessel;
delivering the gas from the secondary pressure vessel to the primary pressure vessel, wherein the secondary pressure vessel also stores gas when the gas source flow rate exceeds the gas sink flow rate, and wherein the secondary pressure vessel also releases stored gas when the gas source flow rate is less than the gas sink flow rate, and wherein the secondary pressure vessel together with the primary pressure vessel mitigate pressure pulsations in the gas emanating from the gas source;
maintaining a secondary variable state material in a gas releasing state while the system is operating using a secondary state controlling mechanism, wherein the secondary variable state material is in a gas absorbing state when below the secondary state transition condition, and wherein the secondary state transition condition is a temperature of approximately 80° F.;
releasing gas into the gas path from the secondary variable state material while the system is operating; and
maintaining a combined absorptive capacity in both of the variable state materials sufficient to absorb a substantial majority of the gas in the system upon a system shutdown.

58. The method of claim 57, further comprising locating the secondary variable state material inside the secondary pressure vessel.

59. The method of claim 57, wherein the primary variable state transition condition and the secondary variable state transition condition are the same.

60. The method of claim 59, wherein the gas is hydrogen, the gas sink is an internal combustion engine, and the primary variable state material and the secondary variable state material are comprised of a nickel alloy.

61. The method of claim 57, further comprising:
locating the secondary variable state material inside the secondary pressure vessel; and
directing a secondary fluid through a secondary pressure vessel jacket, wherein the secondary pressure vessel jacket is in thermal communication with the secondary variable state material, and the secondary fluid controls the state of the secondary variable state material.

62. The method of claim 61, further comprising using the secondary fluid as a source for the primary fluid.

63. The method of claim 50, further comprising permitting a residual amount of the gas to remain in the gas path, after the system ceased operating, sufficient to supply the gas sink until the gas source produces enough freshly generated gas to supply the gas sink upon a subsequent system startup.
